(19) United States
(12) Patent Application Publication
(10) Pub. No.: US 2010/0312037 A1
(43) Pub. Date: Dec. 9, 2010

(54) TOTAL CONTAINMENT TANK CLEANING SYSTEM

(75) Inventor: Dennis Jackson, Brighton, CO (US)

Correspondence Address: OSHA LIANG/MI, TWO HOUSTON CENTER, 909 FANNIN STREET, SUITE 3500, HOUSTON, TX, 77010, US

(73) Assignee: M-I L.L.C., Houston, TX (US)

(21) Appl. No.: 12/864,798

(22) PCT Filed: Jan. 23, 2009
(86) PCT No.: PCT/US09/31743

§ 371 Date: Jul. 27, 2010

Related U.S. Application Data
(60) Provisional application No. 61/025,005, filed on Jan. 31, 2008.

(51) Int. Cl. B09B 3/00; B09B 5/00; B01J 19/18

(52) U.S. Cl. 588/313; 422/224

(57) ABSTRACT

Disclosed is a method for treating a waste material, the method including: admixing a waste material with a reagent in an enclosed mixing device to form a solid waste; and collecting vapors from the waste material during the admixing; and collecting the solid waste from an outlet of the enclosed mixing device. Also disclosed is a system for treating a waste material, the system including: an enclosed mixing device having at least one inlet, at least one outlet, and a mixing zone for admixing a waste material and a reagent fed to the at least one inlet to form a disposable waste material recovered via the at least one outlet; a vapor recovery system for collecting a vapor from at least a portion of the enclosed mixing device; and a fluid conduit for transporting vapor from the at least a portion of the enclosed mixing device to a vapor recovery system.

### BACKGROUND OF DISCLOSURE

1. Field of the Disclosure

Embodiments disclosed herein relate generally to systems and processes for the treatment of waste material in which the waste material is treated so as to be suitable for subsequent disposal while limiting the amount of vapor emissions

2. Background

Processes exist in which organic component are recovered from soil or other waste materials via desorption. For example, U.S. Patent Application Publication No. 2002/0100710, U.S. Pat. Nos. 4,990,237 and 5,704,557, and PCT Patent Application Publications WO 1992/008770 and WO 1996/027411, and others disclose the use of heat and/or chemical treatment of waste materials to recover organic components, such as oil.

Other processes may use chemical means to stabilize waste material. For example, U.S. Pat. Nos. 5,690,833 and 5,484,533 disclose a process including the steps of combining waste material with a treatment composition to form crystal growth structures, and adsorbing the waste material within the crystal growth structures, thereby stabilizing the waste material. The treatment composition may include natural zeolite seed, crystalline quartz, and aluminum trihydrate, among other seed materials for forming crystal growth structures.

Recovery of organic material from such waste systems is an admirable environmental endeavor. Caging of organic materials in zeolites may also benefit the environment by trapping at least a portion of the organic materials and limiting their release when landfilled. However, it is not always economical to encage or recover oil or other valuable components from waste materials.

For example, treatment of waste material to make it suitable for disposal according to EPA and or various state regulations may merely require stabilizing, solidifying, or detoxifying of the waste material. Such treated waste material may thus be rendered compliant with the regulations for subsequent disposal.

In a specific prior art process, waste materials are collected via a vacuum truck, pulling air, volatile organic vapors (fumes), and solids from a storage tank to the tank on the vacuum truck. During operation of the vacuum truck, vapors and air are merely exhausted to the atmosphere. The collected waste material is then deposited in an open top roller bin for later treatment. Without immediate treatment, the waste material in the open top roller bin continues to emit vapors to the environment, which may be hazardous and are typically included against a facilities total emissions allotment. Eventually, when enough waste material is collected or the plant operations schedule treatment, the waste is treated so as to stabilize the waste, thus preventing further emissions and rendering the waste suitable for disposal. However, up to three weeks or more may pass between collection and treatment of the waste, thus allowing for significant emissions.

State regulations are increasingly placing limits on the amount of vapor contaminants emitted from a processing facility or chemical plant. Accordingly, there exists a need for systems useful for the treatment of waste material in which the waste material is treated so as to be suitable for subsequent disposal while limiting the amount of vapor emissions.

### SUMMARY OF THE DISCLOSURE

In one aspect, embodiments disclosed herein relate to a method for treating a waste material, the method including: admixing a waste material with a reagent in an enclosed mixing device to form a solid waste; and collecting vapors from the waste material during the admixing; and collecting the solid waste from an outlet of the enclosed mixing device.

In another aspect, embodiments disclosed herein relate to a system for treating a waste material, the system including: an enclosed mixing device having at least one inlet, at least one outlet, and a mixing zone for admixing a waste material and a reagent fed to the at least one inlet to form a disposable waste material recovered via the at least one outlet; a vapor recovery system for collecting a vapor from at least a portion of the enclosed mixing device; and a fluid conduit for transporting vapor from the at least a portion of the enclosed mixing device to a vapor recovery system.

Other aspects and advantages will be apparent from the following description and the appended claims.

### BRIEF DESCRIPTION OF DRAWINGS

FIG. 1 is a simplified schematic diagram of a waste treatment system according to embodiments disclosed herein.

### DETAILED DESCRIPTION

In one aspect, embodiments disclosed herein relate to systems, useful for the treatment of waste material, in which the waste material is treated so as to be suitable for subsequent disposal while limiting the amount of vapor emissions. In another aspect, embodiments disclosed herein relate to processes, useful for the treatment of waste material, in which the waste material is treated so as to be suitable for subsequent disposal while limiting the amount of vapor emissions. In other aspects, treatment processes disclosed herein may treat waste materials without the use of added heat, added water, or both.

Systems and processes disclosed herein may be useful for the treatment of various waste materials, including tank bottoms, tank sludge, slop oil waste, heat exchanger sludge, and other waste materials commonly encountered at a chemical plant or refinery. Waste materials treated via embodiments disclosed herein may include solids at a concentration of greater than or equal to 30 weight percent; greater than or equal to 50 weight percent in other embodiments; greater than or equal to 60 weight percent or more in other embodiments; and greater than or equal to 70, 75, 80, 85 or 90 weight percent in yet other embodiments.

Such waste materials may be admixed, according to processes described herein, with a reagent to form a mixture suitable for disposal. Suitable reagents may include fly ash, kiln dust, bentonite, and mixtures thereof. In selected embodiments, it has been found that bentonite stabilizes the waste material such that it is suitable for disposal, meeting or exceeding the regulatory requirements.

In some embodiments, the waste material may be admixed with reagent at a weight ratio ranging from 1:10 to 10:1. In other embodiments, the waste material may be admixed with reagent at a weight ratio ranging from 1:5 to 5:1; 1:2.5 to 2.5 to 1 in other embodiments; and from 1.5:1 to 1:1.5 in yet other embodiments.

Admixture of the reagent and waste material may be performed in a pug mill, paddle mixer, plow blender, clay mixer, dust mixer, ribbon blender, screw conveyor or other mixing devices commonly used to grind and/or mix solid materials. In some embodiments, the waste material may contain light hydrocarbons and other light components that may become vapors during the treatment of the waste material. To prevent the release of vaporous emissions during treatment, admixture of the waste material and reagent may be performed under vacuum, allowing recovery, disposal, and/or destruction of any vaporous materials emitted during the treatment process.

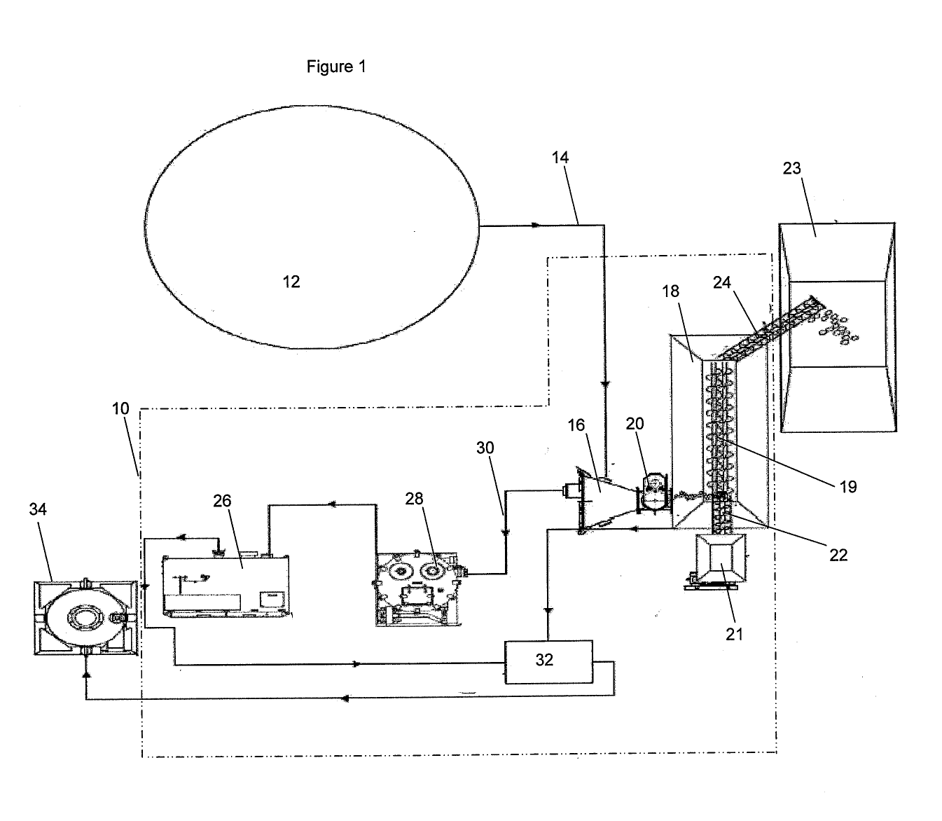

Referring now to FIG. 1, a treatment system 10 useful for treating waste material according to embodiments disclosed herein is illustrated. A storage tank 12, or any other vessel or process equipment containing sludge or other waste material, may be fluidly connected to treatment system 10 via conduit 14. Waste material may be transported through conduit 14 to a feed hopper 16 of an enclosed mixing device 18 via a pump, vacuum, an augur, or other transport means. It is preferable that transport of the waste material be conducted without the use of water or other fluids, as these only add to the amount of waste being processed.

Waste material in feed hopper 16 may be fed to enclosed mixing device 18 via feed valve 20. Feed valve 20 may be a butterfly valve, a shuttle valve, or any other type of valve or device suitable for controlling flow of the waste material being processed, such as a high solids content sludge.

Reagent may be fed from reagent storage tank 21 to enclosed mixing device 18 via augur 22 or other suitable transport and flow control devices. Augur 22 may be equipped with a variable speed controller, for example, so as to allow for manipulation of the reagent feed rate. The reagent and waste material are then blended in a mixing zone 19 of enclosed mixing device 18, stabilizing the waste material. Following admixture of the reagent and waste material, the stabilized product may be collected in a storage vessel 23. In some embodiments, treated waste material may be transported from enclosed mixing device 18 to storage vessel 23 via a discharge augur 24. Storage vessel 23, in some embodiments, may be a transportable storage vessel, such as a roll off bin, a rail car, or the like.

Containment of vaporous emissions from the waste material may be performed using a vacuum system 26, such as offshore vacuum systems available from M-I LLC, Houston, Tex. Vacuum system 26 may be fluidly connected to one or both of the feed hopper 14 and mixing zone 19 of enclosed mixing device 18, and may provide the vacuum for transport of the waste material from tank 12 to feed hopper 14, in some embodiments. When vacuum system 26 is connected to both enclosed mixing device 18 and feed hopper 14, a majority (50% or greater, by weight) of the light components in the waste material may be pulled from the waste material in feed hopper 14 and collected in the vacuum system, and a minor amount of vapors may be generated during treatment, such as due to any heat generated during the reagent mixing process.

A shock tank 28 may be provided to protect vacuum system 26 from any solids or liquids that may enter conduit 30 fluidly connecting feed hopper 14 to vacuum system 26. Vapors and any condensate that may form in the vacuum system may be fed to a surge tank 32 for further treatment or disposal. As illustrated in FIG. 1, such vapors and condensate may then be fed to a vapor recovery system 34. In some embodiments, vapor recovery system 34 may be a thermal oxidizer, used to convert the vapors to carbon dioxide and water, such as a Thermal Oxidizer Vapor Recovery System (such as available from Sierra Process Systems, Inc.). Processing of waste vapors in a thermal oxidizer may be suitable, for instance, where a large amount of air is transported with the waste material from storage tank 12. In various embodiments, the system may be used for both air and non-air abatement cleaning.

The treated waste material, which is stabilized and no longer a regulated waste, may be disposed of via landfill or other common disposal methods as permitted by local or jurisdictional regulations. In some embodiments, the treated waste material may be used as a road mix, such as by blending with dirt or other materials.

In some embodiments, treatment system 10 may be mounted on a skid, so as to be transportable between locations. For example, the vacuum system, surge tank, shock tank, feed hopper, mixing device, reagent storage tank, reagent feed augur, and the discharge hopper may be arranged on a skid. Fluid connections may be provided so as to connect a storage tank to be cleaned to the feed hopper and to connect the vacuum system to a vapor recovery system. Additionally, the skid may include a control system for operating the treatment system equipment.

### Examples

A tank bottoms treatment/solidification process similar to that illustrated in FIG. 1 was used for treatment of tank bottoms at a oil production facility. Tank bottoms were treated with bentonite as a reagent, solidifying the waste material. The mixing device used was a pug mill, and the bentonite feed auger included a variable frequency drive (VFD). Tank bottoms were fed to the pug mill at a feed rate of about 0.8 bbl/min, and bentonite was fed at a rate of 1 super sack (2500 lbs) per 9 yards of tank material.

Over a period of 5 partial days, approximately 9 roll off bins of treated waste was collected. The treatment process used zero gallons of water during the extraction of the tank bottoms from the storage tank or during the treatment process. The vacuum system and vapor recovery via thermal oxidation operation was successful, with the system meeting or exceeding the local regulatory air quality requirements.

As described above, embodiments disclosed herein may provide a system for the solidification of sludge waste materials, such as tank bottoms, rendering the materials suitable for disposal. Advantageously, embodiments disclosed herein may provide for the treatment of waste materials with no vaporous emissions, allowing for a one-step handling and treatment process, where the treated product may be a non-regulated waste material. Additionally, as the system may be operated without the use of water, treatment systems disclosed herein may be more economical, cleaner, safer, and require less man power than conventional cleaning systems. Embodiments of the treatment systems disclosed herein may also advantageously be used for both air and non-air abatement cleaning.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A method for treating a waste material, the method comprising:
admixing a waste material with a reagent in an enclosed mixing device to form a solid waste; and
collecting vapors from the waste material during the admixing; and
collecting the solid waste from an outlet of the enclosed mixing device.

2. The method of claim 1, further comprising:
transporting the waste material from a first location to a hopper; and
feeding the waste material from the hopper to the enclosed mixing device.

3. The method of claim 2, wherein the transporting comprises using a vacuum to cause the waste material to flow from the first location to the hopper.

4. The method of claim 1, wherein the collecting vapors comprises generating a vacuum in the enclosed mixing device to cause a flow of the vapors from the enclosed mixing device to a vapor recovery system.

5. The method of claim 2, further comprising collecting vapors from the waste material in the hopper.

6. The method of claim 5, wherein the collecting vapors comprises generating a vacuum in the enclosed mixing device and the hopper to cause a flow of the vapors to a vapor recovery system.

7. The method of claim 1, further comprising combusting the collected vapors to form at least carbon dioxide and water.

8. The method of claim 1, wherein the method is performed without the use of added water.

9. The method of claim 1, wherein the reagent comprises at least one of fly ash, bentonite, and kiln dust.

10. The method of claim 9, wherein the reagent comprises bentonite.

11. The method of claim 1, wherein the waste material comprises tank bottoms.

12. A system for treating a waste material, the system comprising:
an enclosed mixing device having at least one inlet, at least one outlet, and a mixing zone for admixing a waste material and a reagent fed to the at least one inlet to form a disposable waste material recovered via the at least one outlet;
a vapor recovery system for collecting a vapor from at least a portion of the enclosed mixing device; and
a fluid conduit for transporting vapor from the at least a portion of the enclosed mixing device to a vapor recovery system.

13. The system of claim 12, further comprising:
a vacuum system for generating a pressure differential to cause a flow of vapors from the at least a portion of the enclosed mixing device to the vapor recovery system.

14. The system of claim 12, wherein at least a portion of the system is mounted on a mobile skid.

15. The system of claim 12, wherein the at least a portion of the enclosed mixing device comprises at least one of a feed hopper attached to an inlet of the enclosed mixing device and a mixing zone of the enclosed mixing device.

16. The system of claim 13, further comprising a shock tank to prevent a flow of solids and liquids from the enclosed mixing device to the vacuum system.

17. The system of claim 12, wherein the vapor recovery system comprises a thermal oxidizer.

18. The system of claim 12, further comprising a feed device for transporting the tank bottoms from the feed hopper to the enclosed mixing device.

19. The system of claim 12, further comprising a feed device for transporting the reagent to the enclosed mixing device.

20. The system of claim 12, further comprising a reagent feed hopper for supplying reagent to the feed device for transporting the reagent.
